(19) United States
(12) Patent Application Publication
(10) Pub. No.: US 2002/0158902 A1
(43) Pub. Date: Oct. 31, 2002

(54) Method and apparatus for automatically publishing associate information

(76) Inventors: Bryce H. Hooker, Hilliard, OH (US); David A. Parfrey, Columbus, OH (US)

Correspondence Address: Robert R. Lech, Arter & Hadden LLP, Suite 2100, 10 West Broad Street, Columbus, OH, 43215-3422, US

(21) Appl. No.: 09/845,618

(22) Filed: Apr. 30, 2001

(51) Int. Cl. G06F 13/00; G06F 3/00

(52) U.S. Cl. 345/744; 345/747

(57) ABSTRACT

A method for automatically constructing a customized associate web site is disclosed. The method includes the step of receiving presentation preferences of the associate. The method also includes the step of receiving via an intuitive graphical user interface associate data uniquely describing the associate. The method further includes the step of assembling the presentation preferences and associate data, thereby creating a customized web site. Prior to publication, a preview of the customized web site may be presented. The method also includes the step of publishing the customized web site. An apparatus and article of manufacture are also disclosed for implementing the steps of the method.

### BACKGROUND OF THE INVENTION

1. Technical Field

The present invention is generally related to methods and systems for automatically creating an HTML document or other electronic publication. More specifically, the present invention is related to a method and apparatus for enabling an member of an organization to automatically publish a customized Web page based on parameters defined by the organization and certain information associated with the member.

2. Background Art

The World Wide Web (“WWW”) was developed in the early 1990's. The World Wide Web began as a GUI-based hypertext browser and editor for use on the Internet, a global network of interconnected computers. Over the past decade, communications, protocols and browsers have improved, and today a significant percentage of consumers and businesses make daily use of the Internet and the World Wide Web.

Typically, documents published on the Internet are written in Hypertext Markup Language (“HTML”), Extesible Markup Language (“XML”) or a similar language designed to present information electronically. Collections of such documents are often referred to as Web sites, with each document being a separate “Web page”.

Since the creation of the original WWW browser/editor in the early 1990's, a number of HTML and XML editors have been designed and used to create and maintain Web pages. Examples of such editors include “FrontPage” distributed by Microsoft Corporation and “AOLpress” distributed by America Online, Inc. Such HTML editors enable a user to create an HTML document for publication on the Internet or an Intranet, a private computer network. While such editors support a number of functions which may be used by an experienced user, they offer little assistance to a novice user. An extensive and time consuming learning curve must be overcome in order to productively use such editors to create even a rudimentary Web page, let alone a Web site.

In many professional service industries such as, for example, real estate sales, legal services, medical services and accounting services, it is advantageous for a firm to have a Web site describing and promoting itself as an organization. In such industries, it is also advantageous for each of the agents or associates of the firm to have his/her own Web site describing his/her particular background, interests, qualifications and specialties.

Regarding the construction of associate Web sites, conventional HTML editors have several shortcomings. Construction cost and/or efficiency of creation is a significant concern. Most service professionals do not have the requisite computer training to construct their own Web site. As described above, such professionals would have a formidable learning curve which would require extensive time and/or expense to overcome. In order to construct an individual Web site, either associates would need to receive training regarding the use of HTML editors or the firm would need to provide technicians to construct each associate's Web site. In either event, the cost to the firm in time and resources is significant.

Another shortcoming of conventional HTML editors is that they do not allow firms to control the content of associates' Web sites. Because each associate is a representative of the firm, the firm would understandably wish to retain some control over the information presented by the associate. While some firms provide a suggested template, this approach has the added drawback of resulting in every associate's Web site to have such a similar construction that it is obvious to a potential customer that each associate Web site is merely a copy of a template, thereby providing no differentiation between associates.

A related shortcoming of conventional HTML editors is that, aside from firm policies, they do not enable the firm to require that an associates' Web page have a consistent look and feel that is consistent with the taste of the firm. In short, conventional HTML editors do not provide a firm with any control regarding Web sites created by its associates.

Yet another shortcoming of conventional HTML editors is that the user may not truly preview a Web site under construction. While most HTML editors provide the user with a general idea of what a page will look like and how it will operate, a true preview of the page is not possible without publishing it.

Consequently, a need exists for a method and apparatus for creating a Web site which address the shortcomings of presently available HTML document editors and Web page publishing tools. Specifically, a need exists for a document creation utility that:

Enables a novice user to easily and efficiently create a Web site using an intuitive interface;

Enables a firm to maintain automated control regarding the content of an associate's Web page;

Permits a firm to automatically impose a consistent look and feel among its associates' Web sites; and

Allows a user to accurately preview a Web site that has been created but not published.

### SUMMARY OF THE INVENTION

One aspect of the invention relates to a method for automatically constructing a customized associate web site. The method includes the step of receiving presentation preferences from the associate. The method also includes the step of receiving via an intuitive graphical user interface associate data uniquely describing the associate. The method further includes the step of assembling the presentation preferences and associate data, thereby creating a customized web site. The method concludes with the steps of displaying preview of the customized web site and publishing the customized web site.

According to a second aspect of the invention, an apparatus is described for automatically constructing a customized associate web site. The apparatus includes a means for receiving presentation preferences and a means for receiving via an intuitive graphical user interface associate data uniquely describing the associate. The apparatus also includes a means for assembling the presentation preferences and associate data, thereby creating a customized web site. The apparatus further includes a means for presenting a preview of the customized web site and a means for publishing the customized web site.

According to a third aspect of the invention, an apparatus is described for automatically constructing a customized associate web site. The apparatus includes a processor and a memory connected to the processor. The memory stores a program to control the operation of the processor, and the processor is operative with the program in the memory to perform the step of receiving presentation preferences from the associate. Processor also performs the step of receiving via an intuitive graphical user interface associate data uniquely describing the associate. The processor further performs the step of assembling the presentation preferences and associate data, thereby creating a customized web site. The processor then causes a preview of the customized web site to be displayed and causes the customized web site to be published.

According to a fourth aspect of the invention, a computer-readable storage medium is described. The medium is encoded with processing instructions for directing a computer to perform the steps of a method for automatically constructing a customized associate web site.

An advantage of the present invention is that an associate having minimal computer skills can easily and efficiently design, construct, preview and publish a customized Web site within parameters defined by the associate's affiliated firm.

Another advantage of the present invention is that the firm can automatically control both the content and the presentation of the Web sites published by its associates.

The objects, features and advantages of the present invention are readily apparent from the following description of the preferred embodiments when taken in connection with the accompanying drawings.

### BRIEF DESCRIPTION OF THE DRAWINGS

For a more complete understanding of the present invention and the advantages thereof, reference is now made to the following description taken in conjunction with the accompanying drawings in which like reference numbers indicate like features and wherein:

FIG. 1 is a schematic block diagram illustrating the hardware environment of an embodiment of the present invention;

FIG. 2 is a block diagram illustrating the primary method steps of the preferred embodiment of the present invention;

FIG. 3 is a screen display illustrating the selection of presentation preferences according to the preferred embodiment;

FIG. 4 is a screen display illustrating the associate information form of the preferred embodiment;

FIG. 5 is a screen display illustrating the selection of pages to be included in the associate Web site according to the preferred embodiment;

FIG. 6 is a screen display illustrating the selection and formatting of content for one selected page according to the preferred embodiment; and

FIG. 7 is a screen display illustrating the previewing and publication of the associate Web page according to the preferred embodiment.

### DETAILED DESCRIPTION

Hardware Environment

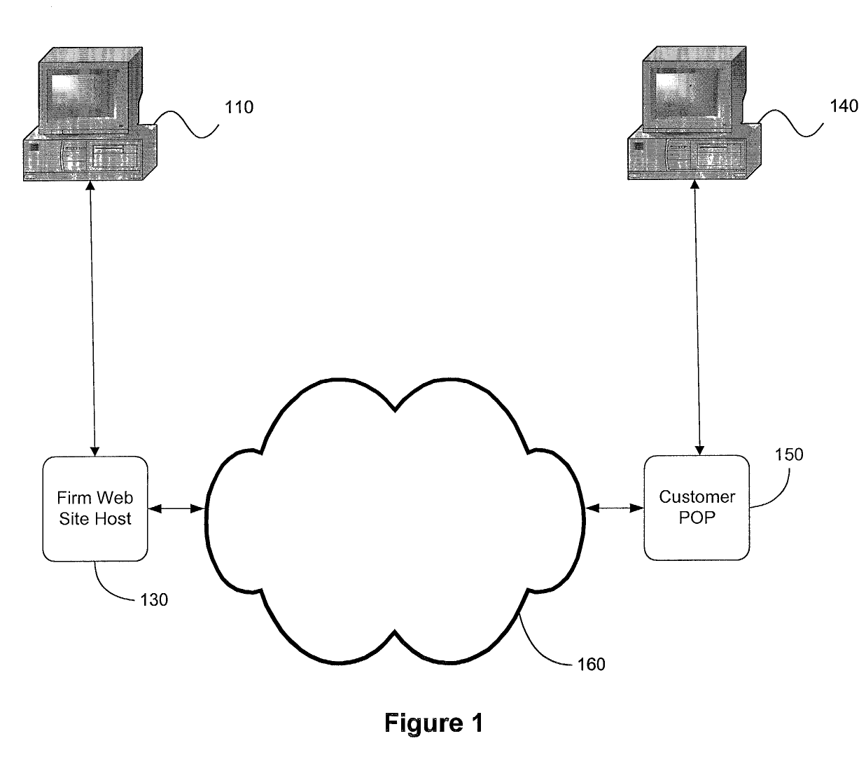

The present invention preferably operates in the hardware environment illustrated in FIG. 1. Associate personal computer (“PC”) 110 is an IBM compatible computer running a Microsoft Windows™ operating system and having an Intel Pentium™-based processor, and sufficient RAM and hard disk storage to run typical applications. PC 110 is used by an associate to execute a web site builder application that is either stored locally or received from firm web host 130. In addition to firm resources to associate PC 110, host 130 provides PC 110 access to the network of computers known as the Internet 160.

A customer or potential customer of the firm utilizes PA 140 to access the Internet 160 to receive information regarding the firm and the associate. PC 140 communicates with customer point-of-presence (“POP”) 150 which, in turn, communicates with the Internet 160.

This preferred hardware configuration enables the associate to automatically publish a Web site that is associated with the firm on the Internet. The configuration further enables a customer of the firm to view the published Web site using a standard PC including an Internet web browser.

Software Application

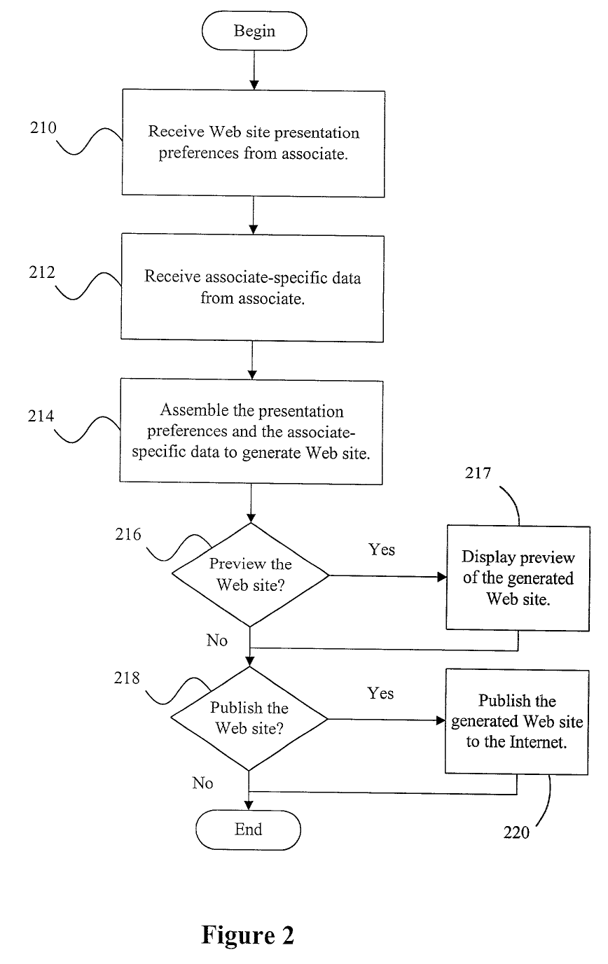

Referring now to FIG. 2, there is depicted a block diagram illustrating the steps that an automatic Web site generation application performs in accordance with the present invention. At step 210, the application receives input from an associate indicating the Web site presentation preferences that will be applied to the generated Web site. At step 212, the application receives associate-specific data input by the associate describing the associate's practice. Such associate-specific data may describe, for example, the associate's educational background, professional experience, specialties, interests and contact information.

At step 214, the data received during steps 210 and 212 is processed, thereby generating a Web site, in some cases a set of HTML documents, that is customized according to the associate's parameters. Of course, the parameters selected by the associate may be limited to a set of parameters defined by the firm. In this way, the firm may control the look and feel of the Web site, as well as the content.

Once the Web site has been generated, the associate is given an opportunity to preview the Web site to ensure that it is acceptable to the associate. At step 216, the associate is prompted to preview the site. If the associate indicates a desire to preview the site, the application processed step 217. Once the associate has completed the preview, if any, the application provides the associate with the opportunity to publish the Web site, as shown by step 218. If the associate wishes to publish the Web site to the Internet, the application publishes the Web site at step 220.

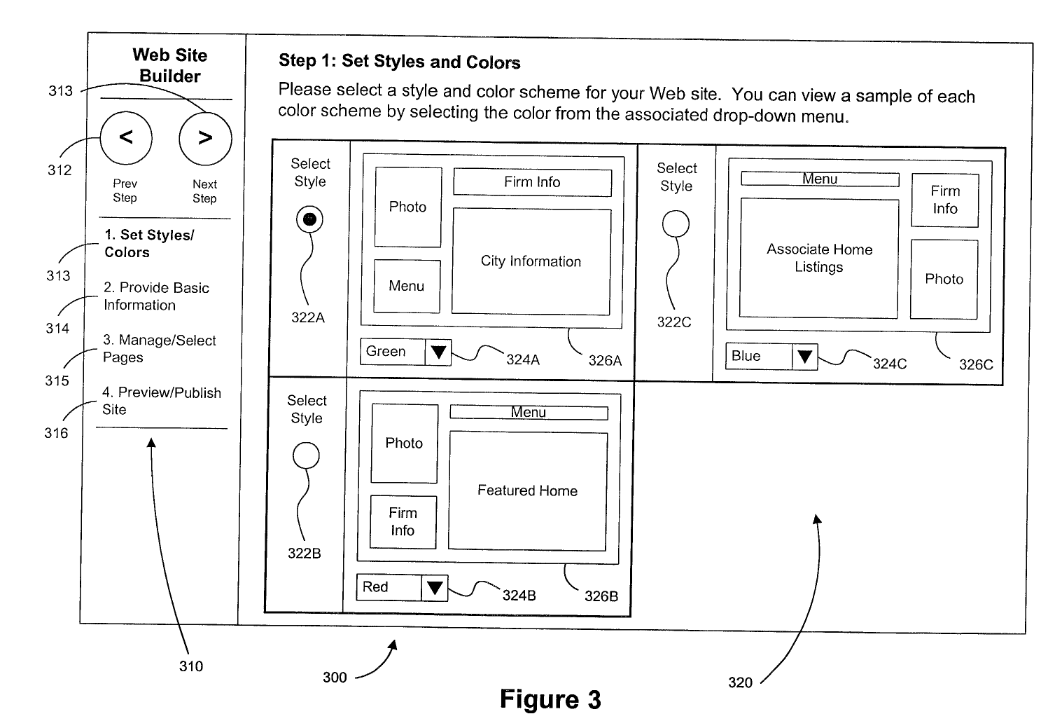

Referring now to FIG. 3, there is depicted a preferred screen display illustrating the manner in which the associate may identify and select the presentation parameters. In order to receive an associate's selection of presentation parameters, the automatic Web site builder application displays a window 300. Window 300 includes a navigation menu 310 and selection area 312 enabling the associate to select his/her preferred style and color scheme.

The navigation menu enables the associate to navigate among steps performed by the automatic Web site builder application. The associate may proceed to the previous or next steps using buttons 311 and 312, respectively. The associate has the further option of jumping to any particular step directly using links 313-316. As shown, link 313 is highlighted to indicate that user is presently executing the first step.

In the selection area 320, Web site styles 326A, 326B and 326C are presented for selection by the associate. For simplicity of explanation, only three styles are illustrated, however the present invention may utilize any number of styles. The associate selects a particular style by selecting an associated radio button 322A, 322B or 322C, and the associate further selects a particular color scheme by selecting among the choices in associated drop-down menus 324A, 324B and 324C. The styles and color schemes are used to differentiate each associate's Web site, while maintaining firm control over their presentation. Styles and colors may be combined, for example, to represent seasonal themes or interest-based themes.

In the present example, style 320A has been marked for selection as indicated by radio button 322A, and a green color scheme has been selected as indicated by drop-down menu 324A. Once the associate has selected both the preferred style and color scheme, he or she may select the “Next Step” button 312 to accept the selections and proceed to the next step to be executed by the Web builder application.

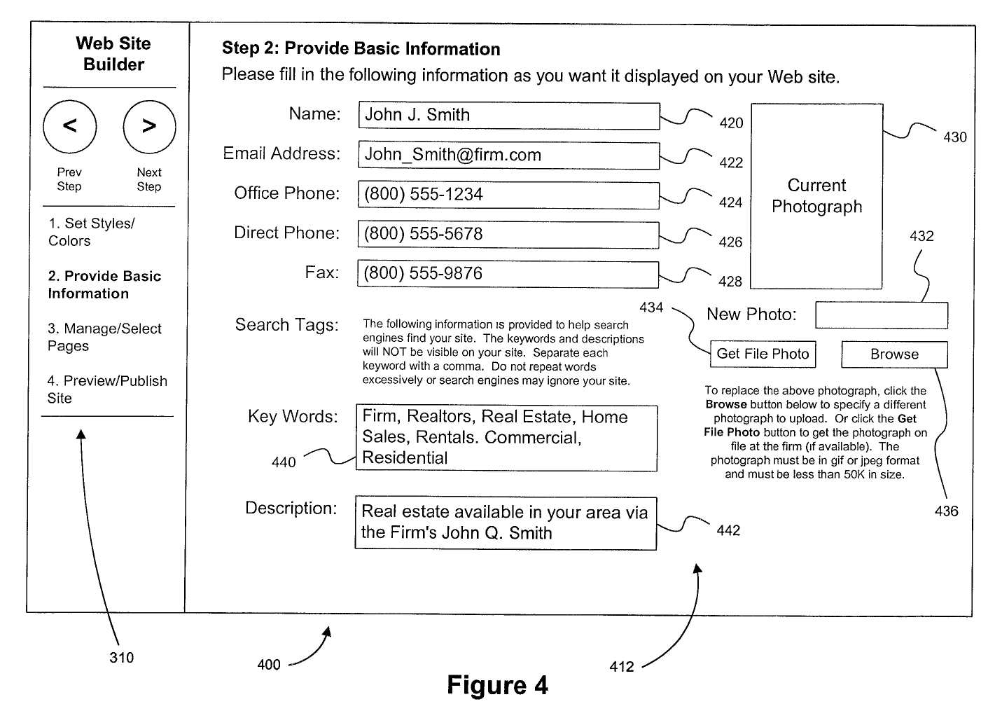

Referring now to FIG. 4, there is depicted a preferred screen display illustrating the manner in which the associate may provide basic associate-specific information. In order to receive the basic information, the automatic Web site builder application displays a window 400. Window 400 includes the navigation menu 310 and a data-entry area 412 enabling the associate to input his/her preferred specific information. As illustrated, the basic information includes identification and contact information, key words describing the associate's practice and a description of the automatically generated Web site. Although not specifically illustrated, the basic information could include any other useful information including, for example, professional specialties, personal interests, educational background, and employment history.

In a preferred embodiment, at least a portion of the information requested in data entry area 412 will have been previously stored on the firm's computer. The previously stored information can be recalled and used to automatically populate the appropriate data entry fields. Once all of this information in place, the associate can change it for the purposes of the web-site. The associate may, for example, elect to upload a different photograph to replace the one originally stored or change any of the text.

In the illustrated data-entry area 412, fields for name 420, email address 422, office phone 424, direct phone 426, and fax 428 are provided to receive basic contact information of the associate. A current photograph 430 in electronic format may be identified. The file name of the digital photograph may be provided by the associate in field 432. Optionally, the associate may retrieve a standard photograph on file with the firm by pressing “Get File Photo” button 434 or may browse files which may contain a custom photograph by clicking “Browse” button 436 and using a standard file selection interface.

In addition to contact information, the illustrated window 400 enables the associate to define the key words that will be used by search engines to index the Web site that is to be automatically generated. The key words selected by the associate are entered into field 440 separated by commas. In “Description” field 442, the associate may further provide a description for the Web site that may be used by indexed search engines. Because the automatically generated Web site is made up of XML pages, the application can extract the associate's metatag information and submit it to search engine sites, such as Yahoo, in an automated fashion.

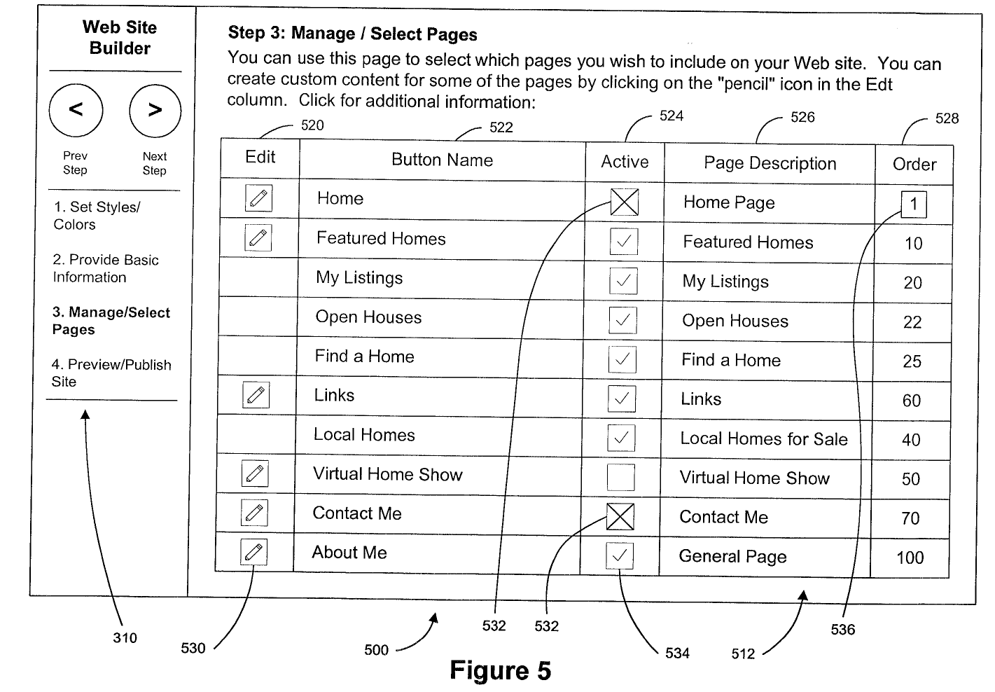

Referring now to FIG. 5, there is depicted a preferred screen display illustrating the manner in which the associate may select and manage pages for the associate's automatically generated Web site. In order to allow the associate to specify which pages should be included in the associate's Web site, Web site builder application displays a window 500. Window 500 includes the navigation menu 310 and a page selection area 512. As illustrated, the page selection area 512 includes a grid having four columns: Edit 520, Button Name 522, Active 524, Page Description 526 and Order 528. Each row of the grid represents a different page of the Web site.

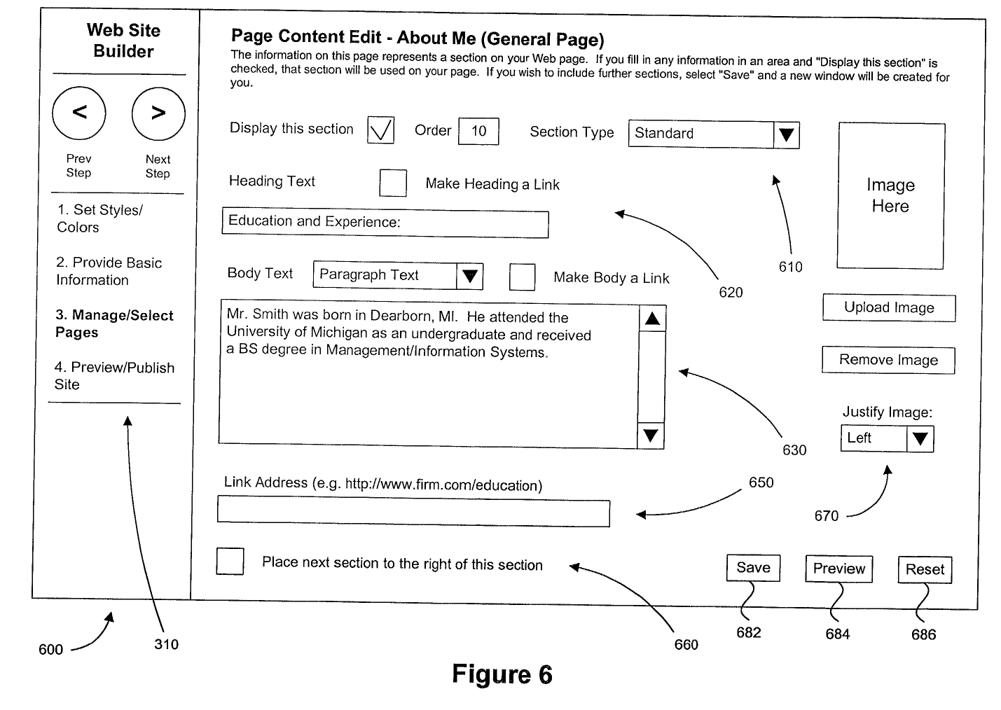

The Edit column 520 indicates whether the associate may customize the contents of the associated page. An edit icon 530 in the Edit column 520 indicates that the corresponding page may be customized by the associate. By clicking on an edit icon 530, the associate can direct the Web Builder Application to request customized information from the associate. This feature is discussed more fully with reference to FIG. 6.

The text populating the Button Name column 522 is used to create a navigation button for the related page of the Web site. The text populating the Page Description column 526 is used as the title of the related page of the Web site. The Active column 524 indicates whether a page of the Web site is included or not, and whether it is required by the firm. Finally, Order column 528 indicates the relative order in which each page of the Web site is displayed. In a preferred embodiment, the rows may be automatically sorted according to the relative order indicated in Order column 528, thereby listing the pages according to the order in which they will appear on the automatically generated Web site.

For example, the first row of the grid corresponds to the associate's “Home Page”. The navigation button representing the page is the “Home” button. The page is the first page of the Web site, and in addition to the page being active, it is mandatory, as indicated by the “X” in the Active column 524. Those pages having an unpopulated Active column 524 will not be included in the Web site, and those having a check mark in the Active column 524 have been selected for inclusion by the associate. As shown by the Order column 528, the “Home” page is the first page of the associate's Web site, and the box surrounding the value indicates that the firm has locked the value, forcing it to be the first page.

It should be noted that any data displayed in window 500 may be locked by the firm to enforce certain firm standards. For example, inclusion of certain pages may be made mandatory, button names, page descriptions or order values may also be predetermined and locked by the firm.

Each page is made up of a series of blocks, or sections, that can be ordered in different manners. Further, each section can be reconfigured in different manners so it fits together with others to produce a whole that looks very complex, but in fact is made up of many simple pieces.

Referring now to FIG. 6, there is depicted a preferred screen display illustrating the manner in which the associate may edit page content for a selected page of the associate's automatically generated Web site. While the illustrated Page Content Edit window 600 relates to the General Page of the Associate's Web site, similar functionality may be applied to any page that may be edited. Specifically, window 600 provides a standardized interface enabling an associate to describe a particular block of information on a page. One or several blocks of information may be combined to fully describe all of the information on a page. This linking of blocks provides significant advantages for the present invention. Specifically, it provides a ubiquitous interface that can be used to perform several functions with one simple dialog. The manner of assembling the blocks can be directed by both the firm and the associate. The firm can lock or impose certain restrictions on the associate, while leaving other aspects unlocked. For example, the firm may require that a particular block of information appear in every associates Web site. The firm may require that a particular block be placed at a certain point in the sequence of linked blocks. The firm could further require that certain information appear in a particular field. While these examples illustrate the power of the present invention, they should not be considered all inclusive.

Reference numeral 610 generally refers to section control information. As shown a check-box is provided allowing the associate to determine whether the section information should be displayed on the automatically generated Web site. An order field is also provided to indicate the order in which sections are displayed on the associated page. Both the “Display this Section” check-box and the “Order” field may be populated and locked by the firm, forcing the section to displayed in a particular order or not displayed at all.

In addition, a drop-down menu is provided to enable the associate to define a “Section Type”. While the fields for a “Standard” section are shown in FIG. 6, other custom section types may be provided as plug-ins to the Automated Web Site Builder Application. For example, a real estate firm may provide a list of custom applications, such as a virtual home tour, a calendar, a mortgage calculator or a map, which may be selected by an associate as a section type. Each custom application will be displayed and function as a separate section in the automatically generated Web page. Each custom application may further require application-specific information from the associate, that is different than the information shown in FIG. 6.

Reference numeral 620 generally refers to heading information. As shown a “Heading Text” field is provided, enabling the associate to provide a customized heading for the section. The heading can be made into a hyperlink by selecting the “Make Heading a Link” check-box.

Reference numeral 630 generally refers to content and display options for the body of the section. The body is made up of lines of text that may be input by the associate using a standard windows text box, as shown. The illustrated text box includes controls for scrolling the text, thereby allowing more text to be input than can be shown on window 600.

The body text may include embedded standard and/or proprietary tags. For example, HTML tags may be used to change text color, point size, or font. Proprietary tags may be defined, such as <TEXTFLOW> for example, to flow text around the associated graphic. In this way, more complicated tasks may be performed by an advanced associate without making the interface too complex for a beginner associate.

The body text can be auto-wrapped, and/or it can have hard carriage returns interspersed. If hard carriage returns are used, then the web Builder Application recognizes that each hard carriage return represents the end of a paragraph if the field is configured as paragraph text or that each hard carriage return represents the end of an item in a list if the paragraph is configured as a bulleted list.

A drop-down menu is provided to enable the associate to define the formatting characteristics of the text making up the body of the section. The body may be formatted, for example, as “Paragraph text”, “Indented Paragraph”, “Centered Text” or “Bullet List”. The body can be made into a hyperlink by selecting the “Make Body a Link” check-box.

Link address information can be input into “Link Address” field, generally referred to by reference numeral 650. The link information provided by the associate will be used for any hyperlinks associated with the section. Formatting check-box, generally referred to by reference numeral 660, enables the associate to determine the position of the next section relative to the current section. If the check-box remains unchecked, the next section will be displayed directly below the present section. If the check-box is populated, the next section will be displayed to the right of the present section, enabling the associate to customize the presentation of sections in columns.

Each section can include an associated image. The associate defines the image using image controls generally referred to by reference numeral 670. Controls enable the display of the image, the selection of the image using the “Upload Image” button, removal of the image using “Remove Image” button and justification of the image using the “Justify Image” drop-down menu. By selecting the “Upload Image” button, the associate may select an image file using a standard directory browsing interface. Preferably, the “Upload Image” function enables the user to resize an uploaded image into one of several standard sizes.

The “Justify Image” function controls placement of the graphic, and therefore also controls text justification and placement with respect to the graphic. Justification alternatives for the image include, for example, left justify, right justify and center. The justification applies only to the section and not to the entire page.

Once the associate is satisfied with the content definition for the section, the associate may press “Save” button 682 causing the application to store the associates content selections and provide a new window 600 for the associate to define the next section. If the associate wishes to view a preview of the section, the associate may click “Preview” button 684 causing the application to present the section as presently defined by window 600. If the associate wishes to begin defining the content of the section from scratch, the associate may click “Reset” button 686 causing window 600 to be redisplayed using default selections. When the user is finished defining the page, the user may select the “Manage/Select Pages” selection to continue to the next page.

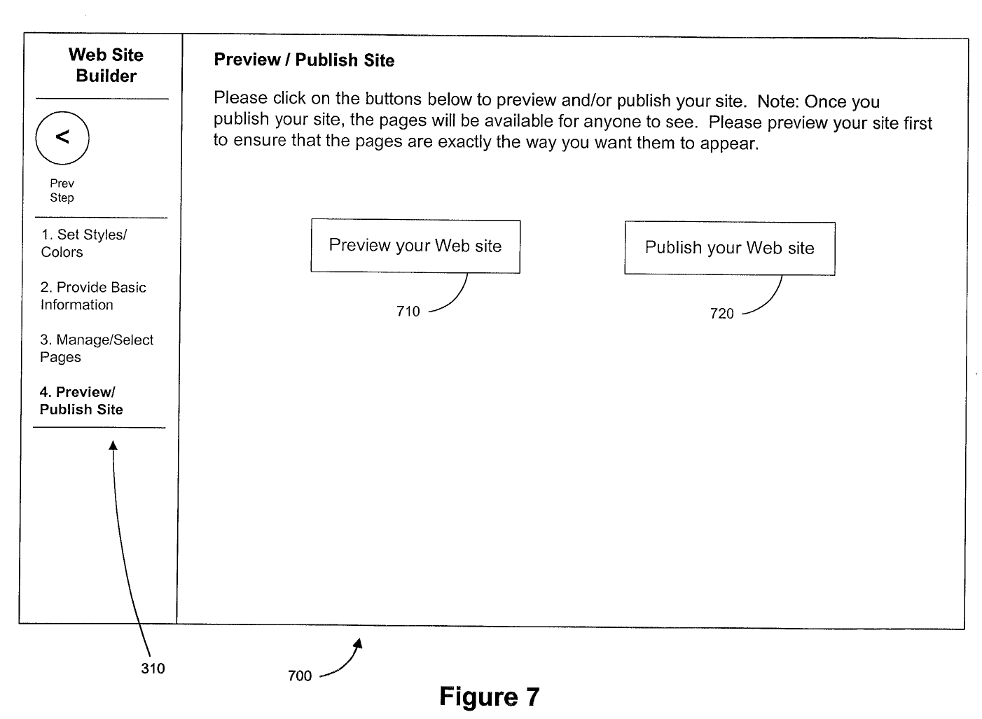

Referring now to FIG. 7, there is depicted a preferred screen display illustrating the manner in which the associate may complete the final step and preview/publish the associate's automatically generated Web site. As shown, the application presents a Preview/Publish Site window 700. By pressing button 710, the associate may cause the application to present an accurate preview of the automatically generated Web site defined by the associate. By pressing button 720, the associate may cause the application to publish the automatically generated Web site so that the general public can access it using the Internet.

From the above description of the invention, those skilled in the art will perceive improvements, changes and modifications in the invention. Such improvements, changes and modifications within the skill of the art are intended to be covered by the appended claims.

Accordingly, it is to be understood that the drawings and description in this disclosure are proffered to facilitate comprehension of the invention, and should not be construed to limit the scope thereof. It should be understood that various changes, substitutions and alterations can be made without departing from the spirit and scope of the invention as defined solely by the appended claims.

What is claimed is:

1. A method for automatically constructing a customized associate web site, comprising:
receiving presentation preferences;
receiving via an intuitive graphical user interface associate data uniquely describing the associate;
assembling the presentation preferences and associate data, thereby creating a customized web site;
presenting a preview of the customized web site; and
publishing the customized web site.

2. A method according to claim 1 wherein the step of receiving presentation preferences includes receiving a selection from among a set of presentation preferences predefined by a firm affiliated with the associate.

3. A method according to claim 1 wherein the step of receiving associate data includes receiving a selection of pages to include in the web site.

4. A method according to claim 1 wherein the step of receiving associate data includes identifying pages which must be included in the web site.

5. A method according to claim 1 wherein the step of receiving associate data includes identifying the order of pages to display.

6. A method according to claim 1 wherein the step of receiving associate data includes identifying information blocks to display on a page of the web site.

7. A method according to claim 6 wherein the step of receiving associate data further includes receiving formatting instructions regarding information blocks to display on a page of the web site.

8. A method according to claim 1 wherein the step of receiving associate data includes identifying the order of information blocks to display on a page of the web site.

9. An apparatus for automatically constructing a customized associate web site, comprising:
means for receiving presentation preferences;
means for receiving via an intuitive graphical user interface associate data uniquely describing the associate;
means for assembling the presentation preferences and associate data, thereby creating a customized web site;
means for presenting a preview of the customized web site; and
means for publishing the customized web site.

10. An apparatus according to claim 9 wherein the means for receiving presentation preferences includes means for receiving a selection from among a set of presentation preferences predefined by a firm affiliated with the associate.

11. An apparatus according to claim 9 wherein the means for receiving associate data includes means for receiving a selection of pages to include in the web site.

12. An apparatus according to claim 9 wherein the means for receiving associate data includes means for identifying pages which must be included in the web site.

13. An apparatus according to claim 9 wherein the means for receiving associate data includes means for identifying the order of pages to display.

14. An apparatus according to claim 9 wherein the means for receiving associate data includes means for identifying information blocks to display on a page of the web site.

15. An apparatus according to claim 14 wherein the means for receiving associate data further includes means for receiving formatting instructions regarding information blocks to display on a page of the web site.

16. An apparatus according to claim 9 wherein the means for receiving associate data includes means for identifying the order of information blocks to display on a page of the web site.

17. An apparatus for automatically constructing a customized associate web site, comprising:
a processor;
a memory connected to said processor storing a program to control the operation of said processor;
the processor operative with the program in the memory to:
receive presentation preferences;
receive via an intuitive graphical user interface associate data uniquely describing the associate;
assemble the presentation preferences and associate data, thereby creating a customized web site;
present a preview of the customized web site; and
publish the customized web site.

18. An apparatus according to claim 17 wherein the processor is further operative with the program in memory to receive a selection from among a set of presentation preferences predefined by a firm affiliated with the associate.

19. An apparatus according to claim 17 wherein the processor is further operative with the program in the memory to receive a selection of pages to include in the web site.

20. An apparatus according to claim 17 wherein the processor is further operative with the program in the memory to identify pages which must be included in the web site.

21. An apparatus according to claim 17 wherein the processor is further operative with the program in the memory to identify the order of pages to display.

22. An apparatus according to claim 17 wherein the processor is further operative with the program in the memory to identify information blocks to display on a page of the web site.

23. An apparatus according to claim 22 wherein the processor is further operative with the program in the memory to receive formatting instructions regarding information blocks to display on a page of the web site.

24. An apparatus according to claim 17 wherein the processor is further operative with the program in the memory to identify the order of information blocks to display on a page of the web site.

25. A computer-readable storage medium encoded with processing instructions for implementing method for automatically constructing a customized associate web site, the processing instructions for directing a computer to perform the steps of:
receiving presentation preferences;
receiving via an intuitive graphical user interface associate data uniquely describing the associate;
assembling the presentation preferences and associate data, thereby creating a customized web site;
presenting a preview of the customized web site; and
publishing the customized web site.
